(19) United States
(12) Patent Application Publication
(10) Pub. No.: US 2012/0321990 A1
(43) Pub. Date: Dec. 20, 2012

(54) ELECTROLYTE MEMBRANE FOR SOLID OXIDE FUEL CELLS, METHOD FOR MANUFACTURING THE SAME, AND FUEL CELL USING THE SAME

(75) Inventors: Ik Whang Chang, Daegu (KR); Young Seok Jee, Seoul (KR); Sang Hoon Ji, Gyeonggi-do (KR); Yoon Ho Lee, Seoul (KR); Suk-Won Cha, Seoul (KR); Ju-Hyung Lee, Seoul (KR)

(73) Assignees: XFC INC., Seoul (KR); SNU R&DB FOUNDATION, Seoul (KR)

(21) Appl. No.: 13/215,378

(22) Filed: Aug. 23, 2011

(30) Foreign Application Priority Data
Jun. 20, 2011 (KR) 10-2011-0059799

(51) Int. Cl. H01M 8/10; B82Y 30/00

(52) U.S. Cl. 429/482; 429/479; 977/779

(57) ABSTRACT

Provided is an electrolyte membrane for solid oxide fuel cells. The electrolyte membrane for solid oxide fuel cells includes two or more deposited layers, wherein each of the deposited layers independently has an average crystal grain size of 5-100 nm and the deposited layers are different from each other in the average crystal grain.

### CROSS-REFERENCE TO RELATED APPLICATIONS

This application claims priority under 35 U.S.C. §119 to Korean Patent Application No. 10-2011-0059799 filed on Jun. 20, 2011, in the Korean Intellectual Property Office, the disclosure of which is incorporated herein by reference in its entirety.

### TECHNICAL FIELD

The following disclosure relates to an electrolyte membrane for solid oxide fuel cells, a method for manufacturing the same, and a fuel cell using the same.

### BACKGROUND

In general, a fuel cell is a type of energy conversion system in which hydrocarbon-based fuel (compounds containing C and H) is allowed to react with air in electrodes and the Gibbs energy difference generated between the two gases is converted into electrical energy. When such fuel cells merely use hydrogen and air, they produce water alone as a product. Therefore, fuel cells are eco-friendly and have relatively high energy conversion efficiency as compared to the existing internal combustion engines.

Such fuel cells include two electrodes composed of an anode (fuel electrode) and a cathode (air electrode), and an electrolyte (membrane) that merely conducts protons (hydrogen ions) and oxygen ions (O²⁻). Different types of electrodes and electrolytes are used in different types of fuel cells, such as those for low-temperature applications (generally, proton exchange membrane fuel cell, PEMFC) and those for high-temperature applications (generally, solid oxide fuel cell, SOFC).

In general, a type of fuel cell, so-called ‘solid oxide fuel cell’, requires an electrode in the form of oxide and an electrolyte. Unlike other types of fuel cells, a solid oxide fuel cell is required to be operated at a high temperature of 600° C. or higher. Thus, metals, such as platinum, palladium or ruthenium, may not be used in such solid oxide fuel cells. Furthermore, polymeric materials may not be used as electrolytes. While such solid oxide fuel cells have significantly higher efficiency than any other types of fuel cells and allow selection of a large spectrum of fuel types, they essentially have disadvantages, including thermal stabilities of their ingredients and selection of an adequate sealing method and current collector material. Therefore, many attempts have been made recently to reduce the operational temperature of a solid oxide fuel cell. Such attempts may be classified broadly into the following two types of methods. The first method is to develop an electrolyte material having high conductivity. Typical examples of such electrolyte materials include ceria-based oxides, for example, gadolinium-doped ceria (GDC) and samarium-doped ceria (SDC). The second method is to fabricate an electrolyte with the smallest possible thickness. This minimizes electrical resistance by reducing the moving distance of protons or oxygen ions that pass through the electrolyte. Recently, such a type of fuel cell is referred to as a thin-film solid oxide fuel cell.

Unlike conventional solid oxide fuel cells, the thin-film solid oxide fuel cells require a process of fabricating an electrolyte in the form of a thin film. Typical methods of the processes include physical vapor deposition (PVD), chemical vapor deposition (CVD), spray pyrolysis and tape casting. The above-listed thin film processes have limitations in decreasing the film density and electrolyte thickness. Even if the processes are carried out without any problems, it is difficult to perform stable insulation of two electrodes. Thus, it is a very important problem to prevent an electrical short circuit caused by the defects of an electrolyte in thin-film solid oxide fuel cells.

### SUMMARY

The present disclosure is directed to providing an electrolyte membrane for solid oxide fuel cells, which is disposed between two electrodes and retains the electrodes stably by preventing an electrical short circuit even when it is fabricated with a thickness of several hundreds nanometers.

The present disclosure is also directed to providing a fuel cell that includes the electrolyte membrane and is capable of being operated at a significantly lower temperature than any other known solid oxide fuel cells.

In one general aspect, there is provided an electrolyte membrane for solid oxide fuel cells, which includes two or more deposited layers, wherein each of the deposited layers independently has an average crystal grain size of 5-100 nm and the deposited layers are different from each other in the average crystal grain size.

According to an embodiment, among the two or more deposited layers, a deposited layer adjacent to an anode may have an average crystal grain size of 5-50 nm. Meanwhile, a deposited layer adjacent to a cathode may have an average crystal grain size of 50-100 nm. In addition, the average crystal grain size of the deposited layer adjacent to the anode and that of the deposited layer adjacent to the cathode may have a difference of 10-95 nm.

According to another embodiment, the two or more deposited layers may include at least one deposited layer selected from the group consisting of a deposited layer of oxygen ion conductive solid oxides, a deposited layer of proton conductive solid oxide, and a deposited layer of oxygen and proton conductive solid oxide.

According to still another embodiment, among the two or more deposited layers, the deposited layer adjacent to the anode and the deposited layer adjacent to the cathode may have a thickness of 0.08-8 μm and 0.02-2 μm, respectively, and the two or more deposited layers may have a total thickness of 0.1-10 μm.

According to still another embodiment, the two or more deposited layers may be deposited via a pulse layer deposition, sputter deposition or physical vacuum vapor deposition process.

According to still another embodiment, the electrolyte membrane for solid oxide fuel cells may further include an insulation layer, which is formed on one surface or both surfaces of the two or more deposited layers as a conformal layer, and has an average crystal grain size between 5 nm and 30 nm or less.

According to yet another embodiment, the insulation layer may be formed of at least one material selected from the group consisting of aluminum oxide, aluminosilicate and titanium dioxide.

In another general aspect, there is provided a solid oxide fuel cell including the electrolyte membrane for solid oxide fuel cells obtained by any one of the above-described embodiments.

Other features and aspects will be apparent from the following detailed description and the claims.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a photograph showing the fuel cell sample according to an embodiment after a test;

FIG. 2 is a schematic sectional view of the fuel cell according to an embodiment;

FIG. 3 is an SEM (Scanning Electron Microscopy) image of the deposited layer adjacent to an anode in the deposited layers forming the electrolyte membrane according to an embodiment;

FIG. 4 is an SEM image of the deposited layer adjacent to a cathode in the deposited layers forming the electrolyte membrane according to an embodiment;

FIG. 5 is an SEM image of the section of the electrolyte membrane according to an embodiment, wherein the lower layer is deposited under 30 mTorr and has a thickness of 840 nm, while the upper layer is deposited under 80 mTorr and has a thickness of 215 nm;

FIG. 6 is a graph showing the test results of electrochemical impedance spectroscopy, wherein the red line (measured at 300° C.) shows a lower electrical resistance than the black line (measured at 250° C.), thereby demonstrating normal operation of the solid oxide fuel cell;

FIG. 7 is a graph showing the current-voltage (I-V) test results of the electrolyte membrane having an electrode area of 25 mm² according to an embodiment, as determined at 250° C.; and

FIG. 8 is a graph showing the open-circuit voltage (OCV) test results of the electrolyte membrane having an electrode area of 25 mm² according to an embodiment, as determined at 300° C.

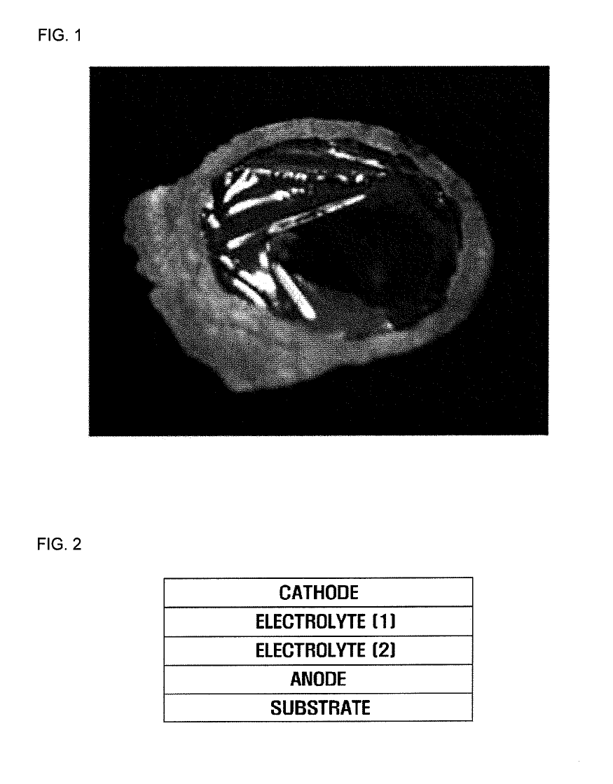

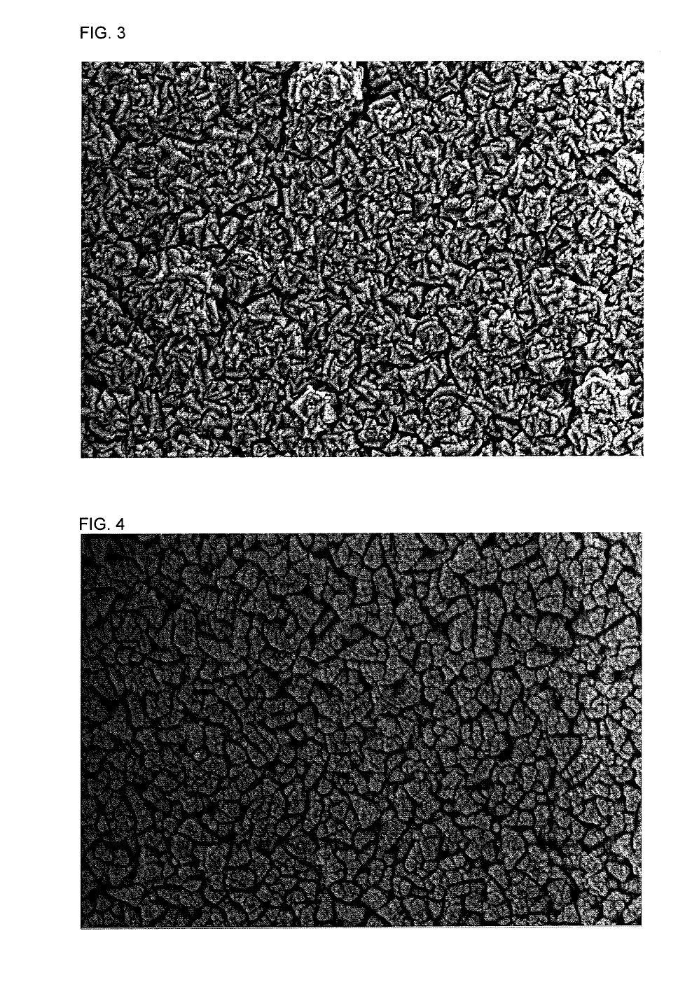

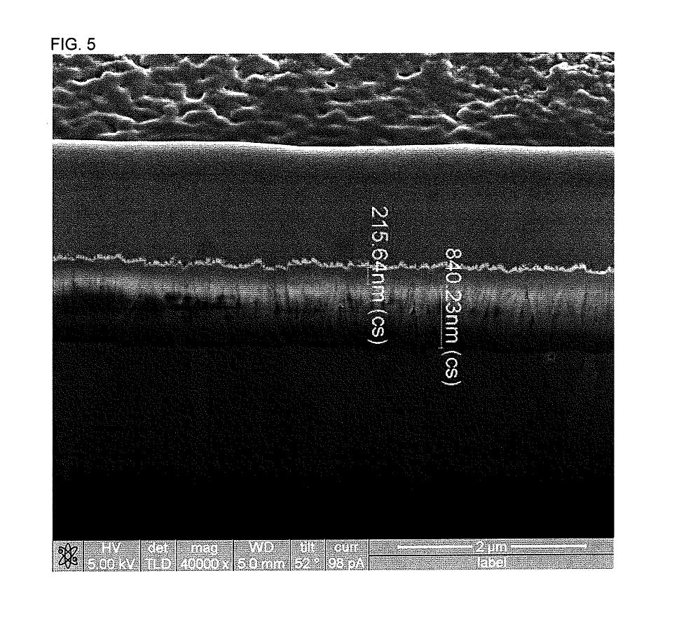

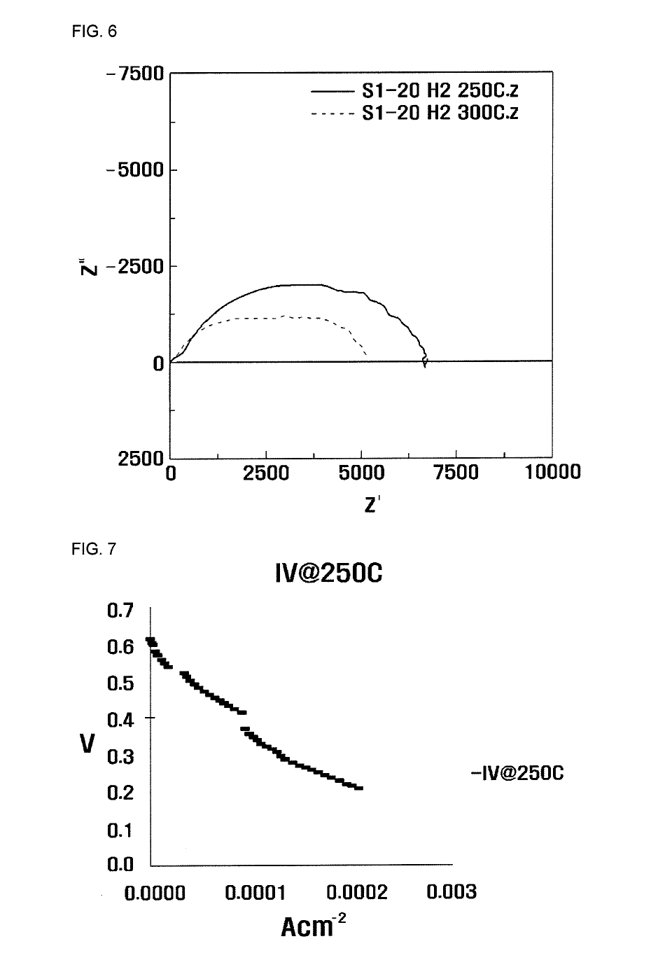

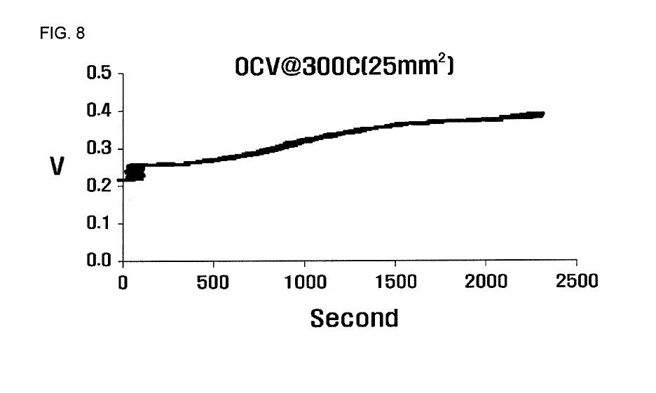

### DETAILED DESCRIPTION OF EMBODIMENTS

The advantages, features and aspects of the electrolyte membrane for fuel cells, a method for fabricating the same and a fuel cell using the same according to the present disclosure will become apparent from the following description of the embodiments with reference to the accompanying drawings, which is set forth hereinafter. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

In one aspect, there is provided an electrolyte membrane for solid oxide fuel cells, which includes two or more deposited layers, wherein each of the deposited layers independently has an average crystal grain size of 5-100 nm and the deposited layers are different from each other in the average crystal grain size. In general, when any defect is generated during the fabrication of an anode layer or an electrolyte membrane, it grows continuously, resulting in an electrical short circuit.

We have conducted many studies and have found that depositing different layers having different average crystal grain sizes separately inhibits the growth of such defects, and thus reduces an electrical short circuit significantly.

According to an embodiment, among the two or more deposited layers, a deposited layer adjacent to an anode has a dense thin film structure with an average crystal grain size of 5-50 nm. Meanwhile, a deposited layer adjacent to a cathode has a thin film structure with an average crystal grain size of 50-100 nm. In addition, the average crystal grain size of the deposited layer adjacent to the anode and that of the deposited layer adjacent to the cathode have a difference of 10-95 nm.

According to another embodiment, the two or more deposited layers include at least one deposited layer selected from the group consisting of a deposited layer of oxygen ion conductive solid oxides, a deposited layer of proton conductive solid oxide, and a deposited layer of oxygen and proton conductive solid oxide.

More particularly, the oxygen ion conductive solid oxide includes at least one selected from the group consisting of: yttrium- or scandium-doped zirconia; ceria doped with at least one selected from the group consisting of gadolinium, samarium, lanthanum, ytterbium and neodymium; and lanthanum gallate doped with strontium or magnesium. In addition, the proton conductive solid oxide includes at least one selected from the parent perovskite group consisting of trivalent element-doped barium zirconate, barium cerate, strontium cerate and strontium zirconate. Meanwhile, the mixed oxygen and proton conductive solid oxide includes at least one selected from the group consisting of trivalent element-doped BaZrO₃, BaCeO₃, SrZrO₃ and SrCeO₃, and Ba₂In₂O₅ doped with at least one cationic element selected from vanadium, niobium, tantalum, molybdenum and tungsten.

According to still another embodiment, among the two or more deposited layers, the deposited layer adjacent to the anode and the deposited layer adjacent to the cathode have a thickness of 0.08-8 μm and 0.02-2 μm, respectively, and the two or more deposited layers have a total thickness of 0.1-10 μm.

It is shown that the above range of thicknesses ensures a significant decrease in optimal operating temperature where a fuel cell realizes maximized quality.

According to still another embodiment, the two or more deposited layers are deposited via a pulse layer deposition, sputter deposition or physical vacuum vapor deposition process.

According to still another embodiment, the electrolyte membrane for solid oxide fuel cells further includes an insulation layer, which is formed on one surface or both surfaces of the two or more deposited layers as a conformal layer and has an average crystal grain size between 5 nm and 30 nm or less.

It is shown that the presence of such an insulation layer allows complete blocking of the pinholes that are present on an electrolyte membrane, cause connection between the two electrodes and thus induce an electrical short circuit.

According to yet another embodiment, the insulation layer is formed of at least one material selected from the group consisting of aluminum oxide, aluminosilicate and titanium dioxide.

In another general aspect, there is provided a solid oxide fuel cell including the electrolyte membrane for solid oxide fuel cells obtained by any one of the above-described embodiments.

To provide such a thin-film type fuel cell, a substrate capable of functioning as a firm support is required. There is no particular limitation in the substrate, and metallic electrodes of platinum, palladium, ruthenium, vanadium, nickel or copper may be used depending on the particular type of ion to be conducted, i.e., proton conductive type, oxygen ion conductive type or mixed ion conductive type. As the oxygen ion conductive electrolyte, a zirconia- or ceria-based electrolyte may be used. As the proton conductive solid oxide, a barium zirconate-, barium cerate-, strontium zirconate- or strontium cerate-based electrolyte may be used.

Further, the cathode material may be the same as the anode material.

### EXAMPLES

The examples and experiments will now be described. The following examples and experiments are for illustrative purposes only and not intended to limit the scope of this disclosure.

### Example 1-1

First, a porous anodized aluminum oxide (AAO) disc having a diameter of 25 mm, a thickness of 100 μm and a pore diameter of 80 nm is used as a substrate for a thin-film type cell.

As an anode on the substrate, Pd is deposited by using a high-purity Pd target to a thickness of 400 nm by using a sputtering process at a power of 200 W, with a distance between the target and the substrate of 80 mm, for a deposition time of 25 minutes under an air pressure of 5 mTorr.

Then, as an electrolyte, BaZr_{0.8}Y_{0.2}O_{3-d} is deposited on the anode to a thickness of 1200 nm by using a BaZr_{0.8}Y_{0.2}O_{3-d} target through a pulsed laser deposition (PLD) process. Herein, the lower layer of the electrolyte is deposited under the PLD conditions of: 600° C., O₂ pressure of 80 mTorr, laser power of 200 mJ, laser frequency of 5 Hz, and deposition time of 128 minutes. In addition, the upper layer of the electrolyte is deposited under the PLD conditions of: 600° C., O₂ pressure of 30 mTorr, laser power of 200 mJ, laser frequency of 6 Hz, and deposition time of 32 minutes. The distance between the target and the substrate (T−S distance) is 75 mm.

After that, as a cathode, Pt is deposited by using a high-purity Pt target to a thickness of about 200 nm by using a sputtering process at a power of 200 W, with a distance between the target and the substrate of 80 mm, for a deposition time of 8 minutes under an air pressure of 50 mTorr. In this manner, a Pd/BaZr_{0.8}Y_{0.2}O_{3-d}/Pt thin film cell including a cathode having an area of 25 mm² is obtained.

### Example 1-2

Example 1-1 is repeated to obtain a thin film cell as a fuel cell, except that the cathode has an area of 30 mm².

### Example 1-3

Example 1-1 is repeated to obtain a thin film cell as a fuel cell, except that the cathode has an area of 50 mm².

### Example 2-1

Example 1-1 is repeated, except that the following operation is carried out after depositing the electrolyte and before depositing the cathode. Trimethyl aluminum is used as a precursor and water is used as a reactant to carry out deposition of an insulation layer Al₂O₃ on the electrolyte. The insulation layer is deposited to a thickness of about 5 nm (50 cycles) by using an atomic layer deposition process under a pressure of 10⁻² Torr at a temperature of 200° C.

### Example 2-2

Example 2-1 is repeated to obtain a thin film cell as a fuel cell, except that the cathode has an area of 30 mm².

### Example 2-3

Example 2-1 is repeated to obtain a thin film cell as a fuel cell, except that the cathode has an area of 50 mm².

### Comparative Example 1

Example 1-1 is repeated, except that the electrolyte is deposited as follows. BaZr_{0.8}Y_{0.2}O_{3-d} is deposited as an electrolyte on the anode to a thickness of 1200 nm by using a BaZr_{0.8}Y_{0.2}O_{3-d} target through a PLD process. However, the electrolyte layer is deposited once under the PLD conditions of: 600° C., O₂ pressure of 80 mTorr, laser power of 200 mJ, laser frequency of 5 Hz, and a distance between the target and the substrate (T−S distance) of 75 mm.

### Comparative Example 2

Example 1-1 is repeated, except that the electrolyte is deposited as follows. BaZr_{0.8}Y_{0.2}O_{3-d} is deposited as an electrolyte on the anode to a thickness of 1200 nm by using a BaZr_{0.8}Y_{0.2}O_{3-d} target through a PLD process. However, the electrolyte layer is deposited once under the PLD conditions of: 600° C., O₂ pressure of 30 mTorr, laser power of 200 mJ, laser frequency of 6 Hz, and a distance between the target and the substrate (T−S distance) of 75 mm.

### Test Example 1

### Evaluation of Electrical Short Circuit

<Evaluation Method>

To determine whether a fuel cell has an electrical short circuit or not, electrochemical impedance spectroscopy (EIS) test data are obtained. For this purpose, EIS systems available from Solartron Co. as 1260A and 1287A are used.

More particularly, AC impedance is measured along the thickness direction of each thin film fuel cell obtained according to Examples and Comparative Examples. The measurement is carried out under the following conditions: a frequency of 0.1-1×10⁶ Hz, an amplitude of 10 mV, frequency sweep at an open-circuit voltage (OCV). As determined by the impedance measurement, appearance of the resistance part alone over the whole range of frequencies is regarded as an electrical short circuit. In addition, when measurement of membrane resistance is allowed with an increase of the resistance value at the axis of imaginary numbers (i.e. the resistance part and the capacitor part appear at the same time) during the sweeping from a low-frequency range to a high-frequency range, it is believed that no electrical short circuit occurs.

<Results>

In the case of Examples 1-1 to 1-3, not only Example 1-1 having a cathode area of 25 mm² but also Example 1-2 having a cathode area of 30 mm² allows measurement of membrane resistance while showing an increase in resistance value at the axis (−Z″) of imaginary numbers. This demonstrates that Examples 1-1 and 1-2 cause no electrical short circuit.

Additionally, in the case of Examples 2-1 to 2-3, it can be observed that all of Example 2-1 having a cathode area of 25 mm², Example 2-2 having a cathode area of 30 mm² and Example 2-3 having a cathode area of 50 mm² cause no electrical short circuit.

On the contrary, it is shown that Comparative Examples 1 and 2 causes an electrical short circuit.

As can be seen from the foregoing, the electrolyte membrane disclosed herein reduces an electrical short circuit caused by defects generated during the fabrication of an electrolyte. More particularly, the electrolyte membrane, including two or more layers deposited in such a manner that the average crystal grain sizes of the layers decrease gradually starting from the layer deposited on the anode, reduces any physical defects, reduces an electrical short circuit, and realizes a thin-film electrolyte membrane. Therefore, a solid oxide fuel cell using the electrolyte membrane may be operated at a lower temperature than any other known solid oxide fuel cells.

While the present disclosure has been described with respect to the specific embodiments, it will be apparent to those skilled in the art that various changes and modifications may be made without departing from the spirit and scope of the disclosure as defined in the following claims.

What is claimed is:

1. An electrolyte membrane for solid oxide fuel cells, which comprises two or more deposited layers, wherein each of the deposited layers independently has an average crystal grain size of 5-100 nm and the deposited layers are different from each other in the average crystal grain size.

2. The electrolyte membrane for solid oxide fuel cells according to claim 1, wherein a deposited layer adjacent to an anode among the two or more deposited layers has an average crystal grain size of 5-50 nm, a deposited layer adjacent to a cathode among the two or more deposited layers has an average crystal grain size of 50-100 nm, and the average crystal grain size of the deposited layer adjacent to the anode and that of the deposited layer adjacent to the cathode have a difference of 10-95 nm.

3. The electrolyte membrane for solid oxide fuel cells according to claim 2, wherein the deposited layer adjacent to the anode among the two or more deposited layers has an average crystal grain size of 10-20 nm, the deposited layer adjacent to the cathode among the two or more deposited layers has an average crystal grain size of 50-100 nm, and the average crystal grain size of the deposited layer adjacent to the anode and that of the deposited layer adjacent to the cathode have a difference of 20-50 nm.

4. The electrolyte membrane for solid oxide fuel cells according to claim 3, wherein the deposited layer adjacent to the anode among the two or more deposited layers has a dense thin film structure, and the deposited layer adjacent to the cathode among the two or more deposited layers has a columnar thin film structure.

5. The electrolyte membrane for solid oxide fuel cells according to claim 1, wherein the deposited layer adjacent to the anode among the two or more deposited layers is deposited by using a pulsed laser deposition process under the conditions of 500-700° C., O₂ pressure of 50-100 mTorr, laser power of 150-250 mJ, laser frequency of 3-8 Hz, and deposition time of 100-200 minutes; and the deposited layer adjacent to the cathode among the two or more deposited layers is deposited under the conditions of 500-700° C., O₂ pressure of 20-40 mTorr, laser power of 150-250 mJ, laser frequency of 3-8 Hz and deposition time of 20-40 minutes.

6. The electrolyte membrane for solid oxide fuel cells according to claim 5, wherein the two or more deposited layers comprise at least one deposited layer selected from the group consisting of a deposited layer of oxygen ion conductive solid oxides, a deposited layer of proton conductive solid oxide, and a deposited layer of oxygen and proton conductive solid oxide.

7. The electrolyte membrane for solid oxide fuel cells according to claim 6, wherein the oxygen ion conductive solid oxide comprises at least one selected from the group consisting of: yttrium- or scandium-doped zirconia; ceria doped with at least one selected from the groups consisting of gadolinium, samarium, lanthanum, ytterbium and neodymium; and lanthanum gallate doped with strontium or magnesium

8. The electrolyte membrane for solid oxide fuel cells according to claim 7, wherein the proton conductive solid oxide comprises at least one selected from the parent perovskite group consisting of trivalent element-doped barium zirconate, barium cerate, strontium cerate and strontium zirconate.

9. The electrolyte membrane for solid oxide fuel cells according to claim 8, wherein the oxygen and proton conductive solid oxide comprises at least one selected from the group consisting of trivalent element-doped BaZrO₃, BaCeO₃, SrZrO₃ and SrCeO₃, and Ba₂In₂O₅ doped with at least one cationic element selected from vanadium, niobium, tantalum, molybdenum and tungsten.

10. The electrolyte membrane for solid oxide fuel cells according to claim 9, wherein the deposited layer adjacent to the anode and the deposited layer adjacent to the cathode among the two or more deposited layers have a thickness of 0.08-8 μm and 0.02-2 μm, respectively, and the two or more deposited layers have a total thickness of 0.1-10 μm.

11. The electrolyte membrane for solid oxide fuel cells according to claim 10, wherein the two or more deposited layers are deposited via a pulse layer deposition, sputter deposition or physical vacuum vapor deposition process.

12. The electrolyte membrane for solid oxide fuel cells according to claim 1, which further comprises an insulation layer, wherein the insulation layer is formed on one surface or both surfaces of the two or more deposited layers as a conformal layer, and has an average crystal grain size between 5 nm and 30 nm or less.

13. The electrolyte membrane for solid oxide fuel cells according to claim 12, wherein the insulation layer is formed of at least one material selected from the group consisting of aluminum oxide, aluminosilicate and titanium dioxide.
